(19) United States
(12) Patent Application Publication
(10) Pub. No.: US 2015/0223308 A1
(43) Pub. Date: Aug. 6, 2015

(54) System using a handheld device for programming lighting instruments and method thereof

(71) Applicant: Yun-Hsiao Yen, Taipei (TW)

(72) Inventor: Yun-Hsiao Yen, Taipei (TW)

(21) Appl. No.: 14/685,613

(22) Filed: Apr. 14, 2015

(30) Foreign Application Priority Data
Apr. 25, 2014 (TW) 103114942

(51) Int. Cl. H05B 37/02; G06F 3/0484; G06F 3/0486; G06F 3/0481

(52) U.S. Cl. CPC H05B 37/0272; G06F 3/04817; G06F 3/04842; G06F 3/0486

(57) ABSTRACT

A system using a handheld device for programming lighting instruments, which is operable on the DALI system, includes a wireless control module electronically connected and integrated with the DALI system; and a handheld device, having two-way communication with the wireless control module wirelessly. The handheld device has a graphical user interface wherein the graphical user interface has functional area blocks. One functional area block, which programs groups of functional blocks, includes menus. The screen of each group menu is divided into first and second display areas. The handheld device accesses the initialized addresses of the lighting instruments in the DALI system from the wireless control module and displays the non-programmed icons of lighting instruments in the DALI system in the second display area. By dragging the lighting instrument icons displayed in the second display area into the first display area, programming groups of the lighting instruments can be accomplished.

### BACKGROUND OF THE INVENTION

1. Field of the Invention

The invention relates to a system using a handheld device for programming lighting instruments and a method thereof, especially, a system using a handheld device for programming lighting instruments and a method thereof that can be remotely set up, control all lighting instruments and integrate the on/off function of all lighting instruments.

2. Description of Related Art

The general lighting systems has entered the age of digital control currently. Therefore, a Digital Addressable Lighting Interface (DALI) communication protocol for digital dimming signal was developed. The DALI is a standard control protocol, which was developed and specified for lighting equipment, having the digital addressable function to perform one-to-one or one-to-many dimming control. Its advantage is to provide those who program the lighting system designs to have a flexibly adjustable, easy to build, easy to maintain system.

However, the current DALI system has been having the issue of lighting instrument installation. When a DALI system controls a lighting instrument with 64 already assigned addresses, there will be 64 different addresses to be programmed into DALI member groups, making the task to be practically difficult. In addition, users need to perform complicated setup prior to the installation and install lighting instruments one by one according to the lighting instrument planning diagrams. As a result, regular users are unable to conduct the installation and modification by themselves. All installation, setup, or modification must completely rely on the system vendors.

Therefore, how to achieve the realization of an easy setup for programming lighting instruments and, easy and convenient to control, becomes an issue that urgently needs to be resolved by the industry.

### SUMMARY OF THE INVENTION

The main objective of the invention is to provide a system using a handheld device installed with a graphical user interface software for programming lighting instruments so that users can achieve the setup by programming remotely and control remotely.

The other objective of the invention is to provide a system using a handheld device for programming lighting instruments in order to program and control the group of lighting instruments in a DALI system.

The system using a handheld device for programming lighting instruments, which achieves the aforementioned objectives and is operable on the DALI system, comprises: a wireless control module electronically connected and integrated with the DALI system; and a handheld device, having two-way communication with the wireless control module wirelessly. In addition, the handheld device has a graphical user interface wherein the graphical user interface has a plurality of functional area blocks. One of the plurality of functional area blocks, which programs groups of functional blocks, includes a plurality of menu. The screen of each group menu is divided into a first display area and a second display area. The handheld device accesses the initialized addresses of the lighting instruments in the DALI system from the wireless control module and also displays the non-programmed icons of lighting instruments in the DALI system in the second display area. By dragging the lighting instrument icons displayed in the second display area into the first display area, programming groups of the lighting instruments can be accomplished.

The DALI system comprises a DALI bus and a lighting instrument set wherein the DALI bus is electronically connected to the wireless control module and the lighting instrument set is electronically connected to the DALI bus.

The wireless control module of the system, which uses a handheld device for programming lighting instruments, of the invention is a WIFI controller or Bluetooth controller, whereas the handheld device is a mobile phone, a tablet computer, or any other computer, communication, consumer (3C) products.

The first display area of the system, which uses a handheld device for programming lighting instruments, of the invention is for users to name each group menu, which is to be programmed, by editing, whereas the second display area is to display icons of the non-programmed lighting instruments.

The method of using a handheld device for programming lighting instruments to achieve the aforementioned objectives and operable on the DALI system, includes the following steps: to provide at least one wireless control module integrated and electronically connected to one DALI system; to provide a handheld device having a two-way communication with the wireless control module wirelessly; to have the handheld device accessing the initialized addresses of the lighting instruments in the DALI system from the wireless control module and also to provide a graphical user interface; to open the graphical user interface and to automatically search for the current configuration condition of a plurality of lighting instruments accessed by the wireless control module; to select one menu of the programming groups of functional blocks in the graphical user interface wherein the screen of the menu is divided into a first display area and a second display area; the non-programmed icons of lighting instruments in the DALI system are displayed in the second display area. By dragging the lighting instrument icons displayed in the second display area into the first display area, programming groups of the lighting instruments can be accomplished.

The method of using a handheld device for programming lighting instruments of the invention further includes the following steps: to select one menu of programming groups of functional blocks in the graphical user interface wherein the programmed icons of lighting instruments in the DALI system are displayed in the first display area. In addition, by dragging the lighting instrument icons displayed in the first display area into the second display area, programming groups of lighting instruments can be removed.

The above and other objects, features and advantages of the invention will become apparent from the following detailed description taken with the accompanying drawings.

### BRIEF DESCRIPTION OF THE DRAWINGS

FIG. 1 is a schematic diagram of the system using a handheld device for programming lighting instruments of the invention;

FIG. 2 is a schematic diagram of the graphical user interface of the system using a handheld device for programming lighting instruments of the invention;

FIG. 3 is a schematic diagram of the dragging operation of the graphical user interface of the system using a handheld device for programming lighting instruments of the invention;

FIG. 4 is a schematic diagram of the completion of operation of the graphical user interface of the system using a handheld device for programming lighting instruments of the invention; and

FIG. 5 is a flowchart of the method of using a handheld device for programming lighting instruments of the invention.

### DETAILED DESCRIPTION OF THE INVENTION

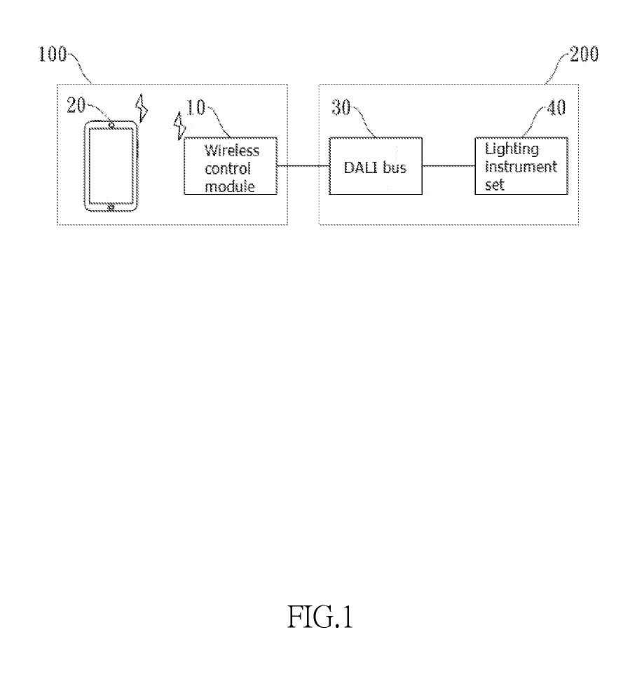

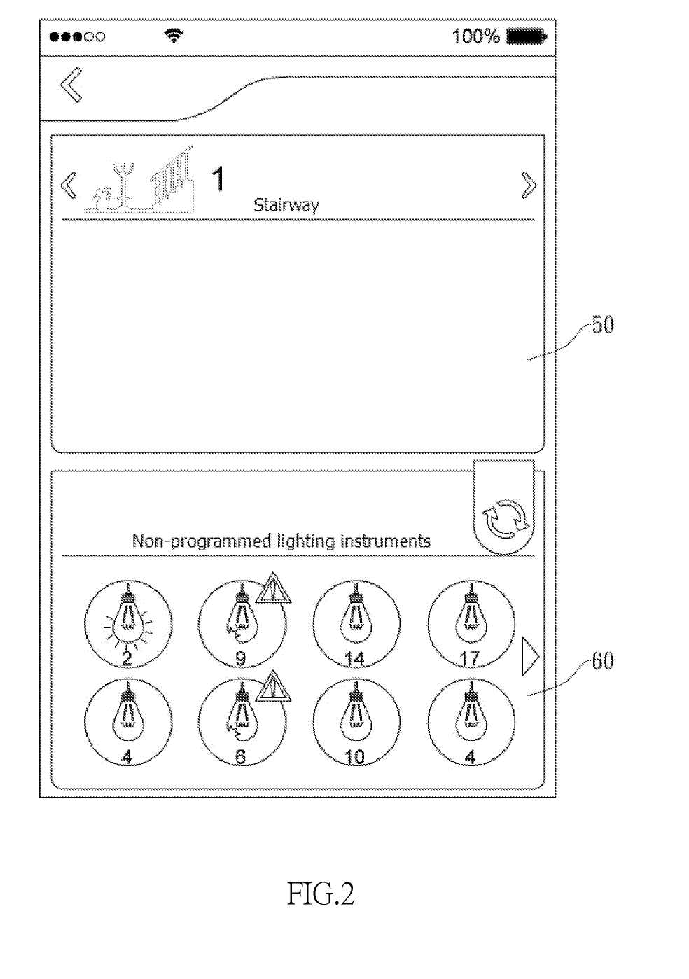

Referring to FIG. 1, a system using a handheld device for programming lighting instruments of the invention, which is operable on the DALI system 200, comprises a wireless control module 10 electronically connected and integrated with the DALI system 200; and a handheld device 20, having two-way communication with the wireless control module 10 wirelessly. The handheld device 20 accesses the initialized addresses of the lighting instruments in the DALI system 200 from the wireless control module 10. The handheld device 20 has a graphical user interface (FIG. 2) for users to use the graphical user interface for programming groups of non-programmed lighting instruments in the DALI system 200.

The DALI system 200 comprises a DALI bus 30 and a lighting instrument set 40 wherein the DALI bus 30 is electronically connected to the wireless control module 10 and the lighting instrument set 40 is electronically connected to the DALI bus 30. Thus, the handheld device 20 accesses the initialized addresses of the lighting instruments 40 in the DALI system 200 from the wireless control module 10; and by using the graphical user interface of the handheld device 20, users can program each lighting instrument into groups.

Referring to FIG. 2, a graphical user interface of the system using a handheld device for programming lighting instruments of the invention is designed with a plurality of functional area blocks. The plurality of functional area blocks comprise functions of programming groups, dimming control, logout, addition of different environment mode, resetting (not shown in the figure). Every functional area block comprises a plurality of menu (not shown in the figure) wherein the screen of every group menu of the programming groups is divided into a first display area 50 and a second display area 60. The first display area 50 is for users to name each group menu, which is to be programmed, by editing. Take the home living environment as an example. Using the terms, stairway, kitchen, bathroom, master bedroom, guest room, study room, children room, living room, etc., program the initialized lighting instruments into different groups through programming groups of lighting instruments, so that it is convenient for users to adjust and control different groups of lighting instruments.

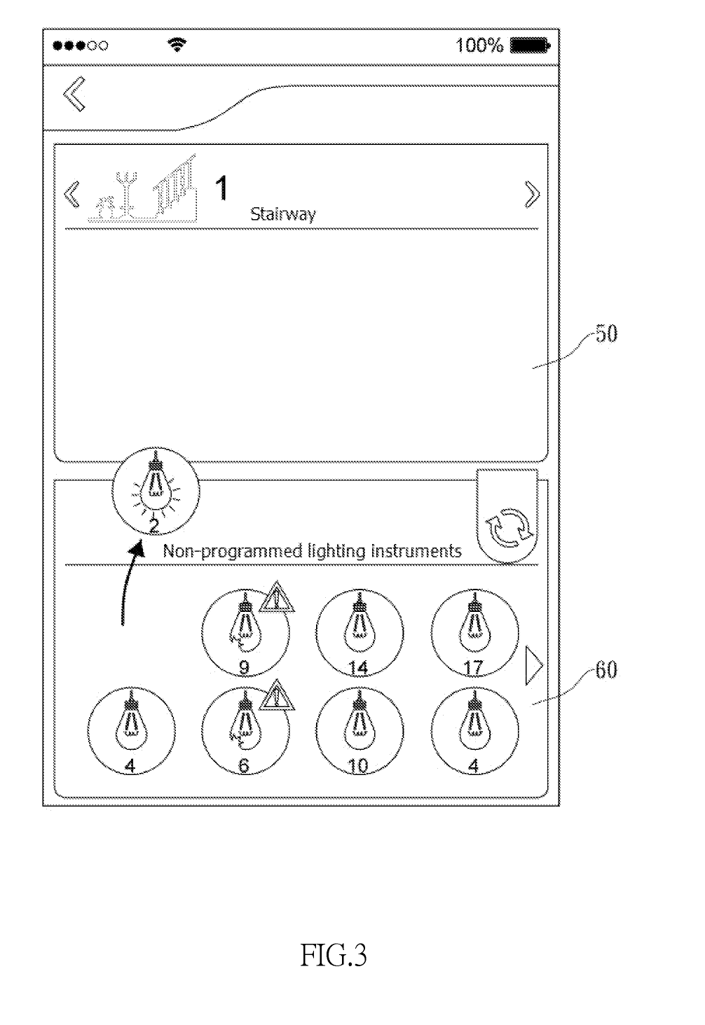

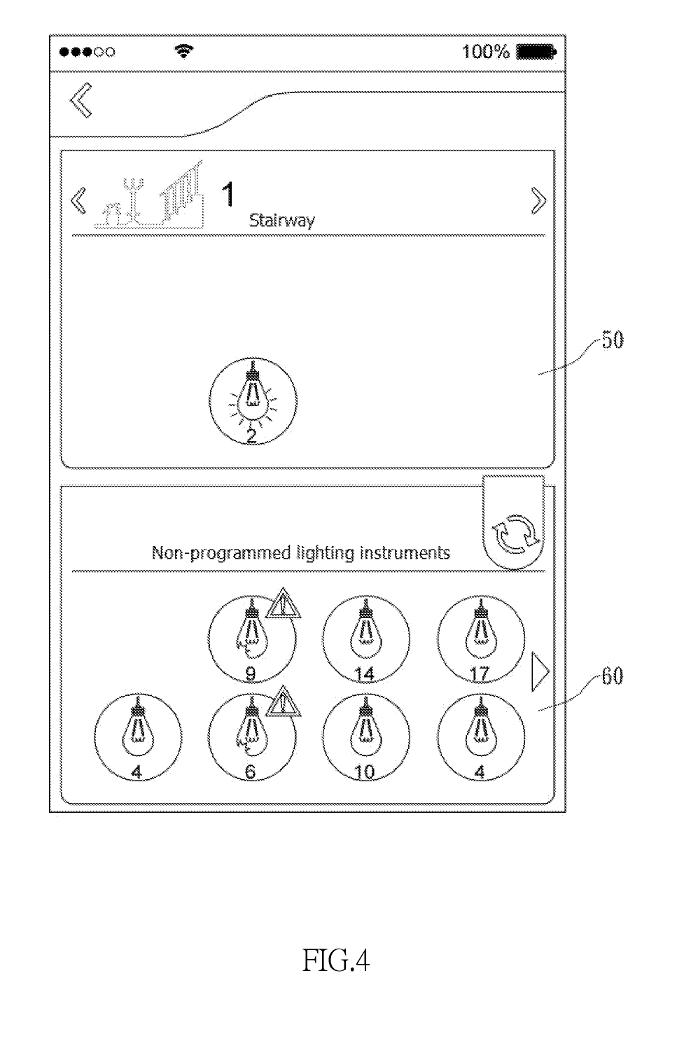

Referring to FIGS. 3 and 4 in conjunction with FIG. 2, in this embodiment, to program the lighting instruments in the stairway is used as an example. When the handheld device 20 accesses the initialized addresses of the lighting instruments in the DALI system 200 from the wireless control module 10; and the icons of non-programmed lighting instruments in the DALI system 200 are displayed in the second display area 60. As shown in FIG. 2, there are a plurality of non-programmed lighting instruments. To program the lighting instrument (labeled “2”) to the group of stairway, drag the lighting instrument icon (labeled “2”) in the second display area 60 into the first display area 50 (as shown in FIG. 3) to complete the programming groups of the lighting instrument (labeled “2”) (as shown in FIG. 4). With the same token, if another lighting instrument is to be programmed in the group of stairway, use the dragging method to drag the non-programmed lighting instrument icon (shown in the second display area 60) into the first display area 50. Or, if user wishes to add another lighting instrument in the group of kitchen, select the kitchen group menu; use the dragging method to drag the non-programmed lighting instrument icon (shown in the second display area 60) into the first display area 50 in order to complete programming the group, thus to have overall control of the stairway group or kitchen group individually. Besides, in this embodiment, the wireless control module 10 is a WIFI controller or Bluetooth controller, whereas the handheld device 20 is a mobile phone, a tablet computer, or any other computer, communication, consumer (3C) product.

On the contrary, to remove the programmed group of a lighting instrument, select the menu from a programmed group where the lighting instrument belongs; using the dragging method, drag an icon of a specific programmed lighting instrument shown in the first display area 50 into the second display area 60 to remove programming the group. After, users can program this lighting instrument again. Those familiar with this domain of technology can reason and understand this process, and thus no further explanations and diagrams are provided here. One thing is worth to mention that icons of lighting instruments marked with a warning sign in FIG. 2 to FIG. 4 of the invention are damaged lighting instruments to be replaced by the users.

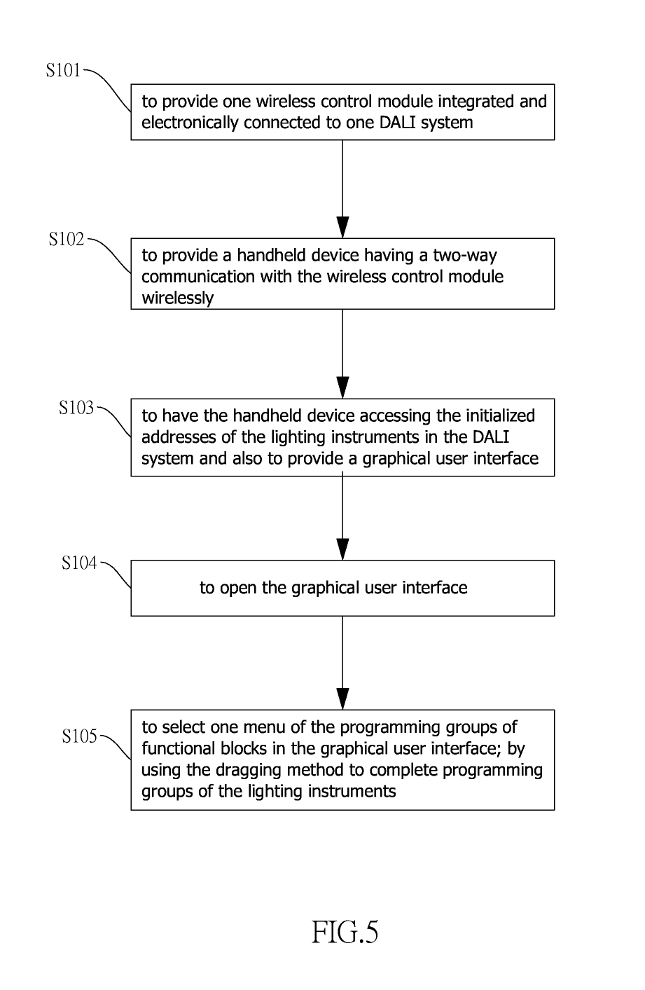

Referring to FIG. 5, a method of using a handheld device for programming lighting instruments of the invention which is operable on the DALI system, includes the following steps: to provide at least one wireless control module integrated and electronically connected to one DALI system (S101); to provide a handheld device having a two-way communication with the wireless control module wirelessly (S102); to have the handheld device accessing the initialized addresses of the lighting instruments in the DALI system from the wireless control module and also to provide a graphical user interface (S103); to open the graphical user interface and to automatically search for the current configuration condition of a plurality of lighting instruments accessed by the wireless control module (S104); to select one menu of the programming groups of functional blocks in the graphical user interface wherein the screen of the menu is divided into a first display area and a second display area; the non-programmed icons of lighting instruments in the DALI system are displayed in the second display area; by dragging the lighting instrument icons displayed in the second display area into the first display area, programming groups of the lighting instruments can be accomplished (S105).

The method of using a handheld device for programming lighting instruments of the invention further includes the following steps: to select one menu of programming groups of functional blocks in the graphical user interface wherein the programmed icons of lighting instruments in the DALI system are displayed in the first display area. In addition, by dragging the lighting instrument icons displayed in the first display area into the second display area, programming groups of lighting instruments can be removed.

The system using a handheld device for programming lighting instruments and the method thereof of the invention, by letting users use a handheld device which is installed with a graphical user interface software and incorporate with a wireless device of having two-way communication with the wireless control module wirelessly, to program the setup and dimming control remotely can be achieved, so that users can easily program and control groups of the lighting instruments remotely.

While the invention has been described in terms of preferred embodiments, those skilled in the art will recognize that the invention can be practiced with modifications within the spirit and scope of the appended claims.

What is claimed is:

1. A system using a handheld device for programming lighting instruments, which is operable on the DALI system, wherein the handheld device has a graphical user interface; the functional area blocks of the programming groups include a plurality of menu; the screen of each group menu is divided into a first display area and a second display area; non-programmed icons of lighting instruments in the DALI system are displayed in the second display area; by dragging the lighting instrument icons displayed in the second display area into the first display area, programming groups of the lighting instruments can be accomplished; on the contrary, by dragging the lighting instrument icons displayed in the first display area into the second display area, programming groups of the lighting instruments can be removed.

2. The system using a handheld device for programming lighting instruments as claimed in claim 1, wherein the DALI system comprises a DALI bus and a lighting instrument set wherein the DALI bus is electronically connected to the wireless control module and the lighting instrument set is electronically connected to the DALI bus.

3. The system using a handheld device for programming lighting instruments as claimed in claim 1, wherein the wireless control module is a WIFI controller or Bluetooth controller, whereas the handheld device is a mobile phone, a tablet computer, or any other computer, communication, consumer (3C) product.

4. The system using a handheld device for programming lighting instruments as claimed in claim 1, wherein the first display area is for users to name each group menu, which is to be programmed, by editing, whereas the second display area is to display icons of the non-programmed lighting instruments.

5. A method using a handheld device for programming lighting instruments, which is operable on the DALI system, comprising the following steps:
to provide at least one wireless control module integrated and electronically connected to one DALI system;
to provide a handheld device having a two-way communication with the wireless control module wirelessly;
to have the handheld device accessing the initialized addresses of the lighting instruments in the DALI system from the wireless control module and also to provide a graphical user interface;
to open the graphical user interface and to automatically search for the current configuration condition of a plurality of lighting instruments accessed by the wireless control module; and
to select one menu of the programming groups of functional blocks in the graphical user interface wherein the screen of the menu is divided into a first display area and a second display area, and the non-programmed icons of lighting instruments in the DALI system are displayed in the second display area, and by dragging the lighting instrument icons displayed in the second display area into the first display area, programming groups of the lighting instruments can be accomplished.

6. The method using a handheld device for programming lighting instruments as claimed in claim 5, further including the following steps: to select one menu of programming groups of functional blocks in the graphical user interface wherein the programmed icons of lighting instruments in the DALI system are displayed in the first display area; in addition, by dragging the lighting instrument icons displayed in the first display area into the second display area, to remove programming groups of lighting instruments.
